(19) United States
(12) Patent Application Publication
(10) Pub. No.: US 2014/0164271 A1
(43) Pub. Date: Jun. 12, 2014

(54) CAREER MANAGEMENT APPLICATION FOR TRACKING, MANAGING, AND APPLYING FOR EMPLOYMENT OPPURTUNITIES

(71) Applicants: Christian K. Forman, Meriden, NH (US); Aliaksandr Iharavich Yakubenka, Berezino (BY); Samantha K. Swett, Meriden, NH (US); Nikitsin Dzmitry Anatolievich, Stolbsty (BY)

(72) Inventors: Christian K. Forman, Meriden, NH (US); Aliaksandr Iharavich Yakubenka, Berezino (BY); Samantha K. Swett, Meriden, NH (US); Nikitsin Dzmitry Anatolievich, Stolbsty (BY)

(73) Assignee: STARTDATE LABS, INC., Meriden, NH (US)

(21) Appl. No.: 14/054,976

(22) Filed: Oct. 16, 2013

Related U.S. Application Data
(60) Provisional application No. 61/734,637, filed on Dec. 7, 2012.
(60) Provisional application No. 61/872,409, filed on Aug. 30, 2013.

(51) Int. Cl. G06Q 10/10

(52) U.S. Cl. CPC G06Q 10/1053
USPC 705/321

(57) ABSTRACT

The present disclosure relates to a system and methods that provide a web-based application, and/or plug-in, to aid a job-seeker in tracking, managing, and applying for potential employment positions. Processing circuitry, suth as that on a user's computer, monitors the user's web activity, activates when the user is on the job application page, and automatically fills in data in the appropriate fields of the webpage.

### COPYRIGHT STATEMENT

A portion of the disclosure of this patent application document contains material that is subject to copyright protection including the drawings. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

1. Field of the Invention

The disclosure relates to the fields of human to machine interaction and database retrieval systems. More specifically the present disclosure relates to an interactive application that may be integrated into an internet browser, wherein usage information is stored on a computer and/or database.

2. Description of the Prior Art

Presently, many companies, corporations, and/or employers create and announce employment opportunities within their organization, over the internet. Each organization may have a unique way to access information about and apply to each employment opportunity. Due to advances in internet security and ever expanding use of the internet, many organizations provide a means for applying for the announced employment opportunities, on their websites. In some instances, such job announcements may even be displayed through third party websites. While each website may differ, information requested and questions asked in the application may be very similar. For job seekers, however, it becomes cumbersome and very time consuming accessing each website and re-typing the same information and answering the same or similar questions.

Advances in network based computer systems have led to the development of graphical user interfaces (GUIs) and javascript programs specifically designed for accessing applications, exchanging data over networks, and/or storing information in on a computer or in a database. For example, internet browser applications are used to access files, applications, and other types of stored information. These applications may display interfaces designed to facilitate interaction between an internet application or internet application interfaces through an internet web browser.

A need therefore exists for a web-browser application that can aide a job seeker in tracking, managing, and applying for employment positions on the internet. More specifically, a web-browser application what will allow the job-seeker to save time and energy while applying for more positions. The present application seeks to address these concerns.

### SUMMARY OF THE INVENTION

The system and methods described herein provide a web-based application, and/or plug-in, to aid a job-seeker in tracking, managing, and applying for potential employment positions. In some aspects, this system and methods may especially assist job seekers who apply for multiple positions with multiple companies or organizations.

In certain aspects, the systems and methods described herein include a monitoring system for a web server comprising storage memory and processing circuitry. The processing circuitry is configured to retrieve user input data from the storage memory, receive employment opportunity content from a remote server, and analyze the employment opportunity content with the user input data to determine a user recommendation level for the employment opportunity. In certain approaches, the employment opportunity content includes employment opportunity information fields. The processing circuitry is configured to populate employment opportunity information fields based on user input data, send populated employment opportunity information fields to a receiving server, communicate with the receiving server to obtain employment opportunity updates related to the received employment opportunity content, and send employment opportunity updates to a user notification system.

In certain approaches, the processing circuitry may identify employment opportunity content from other website content. For example, the processing circuitry may be configured to receive website content from the remote server, access a parameter database having data for classifying employment opportunity content, and analyze the website content with the data for classifying employment opportunity content to determine whether the website content comprises employment opportunity content.

In certain embodiments, the retrieved user input data includes at least one of user resume data, keyword, user response to a question, previously submitted employment application, and previously identified employment opportunity. The remote server may be the receiving server. In certain approaches, the storage memory is remote from the processing circuitry, such as at a portal server. The user notification system may include at least one of email, user portal, text message, cellular telephone system, and social media site.

In certain approaches, the processing circuitry may be further configured to provide user adjusted responses for employment opportunity information fields based on the analysis of the employment opportunity content. For example, the processing circuitry may correct an error in a user response or adjust the language of a response using synonyms or related text to make the response more appropriate for a specific question. The processing circuitry may be configured to display previously received employment opportunity content, such as the title, company, location, date of receiving the content, and date of application of an employment opportunity.

The processing circuitry may be configured to request a user response and receive a user response, for example, to a question on an employment application. In certain approaches, the processing circuitry saves the user response with user input data at the storage memory.

In certain aspects, the systems and methods described herein include a monitoring system for a web server comprising storage memory and processing circuitry. The processing circuitry may be configured to retrieve user input data from the storage memory, receive employment opportunity content with user information fields from a remote server, analyze the employment opportunity content with the user input data to determine a user recommendation level for the employment opportunity, send populated user information fields to a receiving server, communicate with the receiving server to obtain employment opportunity updates related to the received employment opportunity content, and send employment opportunity updates to user notification system.

In certain aspects, the systems and methods described herein include a monitoring system for a web server and processing circuitry configured to receive website content from a remote server; access a parameter database having data for classifying an employment website, analyze the website content with the data for classifying an employment site to determine whether the website content is an employment website, access a portal server to store application data from the employment website in a user database in response to determining that the website content is an employment website, receive user input data, and, in response to the user input data, store user input data in user database.

In certain approaches, the parameter database comprises a list of at least one of websites, keywords, companies, and URLs. In certain approaches, the processing circuitry is further configured to automatically populate information for given application data based on stored user input data. The processing circuitry may be configured to send populated information for application data to an application receiving server. Additionally or alternatively, the processing circuitry may be configured to communicate with the receiving server to obtain employment opportunity updates and send employment opportunity updates to a user notification system.

In certain embodiments, the processing circuitry is configured to provide user adjusted responses for employment opportunity information fields based on the analysis of the employment opportunity content. The processing circuitry may be configured to display previously received employment opportunity content. For example, the previously received employment opportunity content may include at least one of title, company, location, date of receiving the content, and date of application.

In certain aspects, methods for monitoring a web server include a processing circuitry retrieving user data from a storage memory, receiving employment opportunity content from a remote server, analyzing the employment opportunity content with the user data to determine a user recommendation level for the employment opportunity, populating employment opportunity information fields based on stored user input data, sending populated employment opportunity information fields to a receiving server, communicating with the receiving server to obtain employment opportunity updates, and sending employment opportunity updates to a user notification system.

In certain approaches, the methods described herein further include the processing circuitry receiving website content from the remote server, accessing a parameter database having data for classifying employment opportunity content, and analyzing the website content with the data for classifying employment opportunity content to determine whether the website content comprises employment opportunity content. The retrieved user input data may include at least one of user resume data, keyword, user response to a question, previously submitted employment application, and previously identified employment opportunity. In certain approaches, the remote server is the receiving server. In certain embodiments, the storage memory is remote from the processing circuitry.

In certain embodiments, the methods described herein include the processing circuitry providing user adjusted responses for employment opportunity information fields based on the analysis of the employment opportunity content.

The user notification system may include at least one of email, user portal, text message, cellular telephone system, and social media site.

In certain approaches, the processing circuitry displays previously received employment opportunity content. For example, the previously received employment opportunity content may include at least one of title, company, location, date of receiving the content, and date of application. In certain approaches, the processing circuitry requests a user response and receives a user response. The processing circuitry may save the user response with user input data at the storage memory.

One illustrative embodiment is a web-based application, comprising: a computer program installed onto a user's computer, wherein the computer program monitors the user's web activity and activates when the user is on the job application page of a corporate career site, job board, employment opportunity aggregator, job advertisement, or any other employment site. In some embodiments, when activated, the program records the any viewed job information (job title, company, location, description, link, application status) in a 3^{rd} party database and displays a search history in browser panel powered by the plugin. Additionally, job recommendations based on a users job search and application behavior and profile information are displayed in the plugin. Finally, the plugin can also automatically complete common questions asked on standard job applications and enable job seekers to get updates on their job application status directly from the employer to which they are applying.

These and other embodiments are described in more detail herein.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 depicts a user portal for a career management application;

FIG. 2 is a diagram of a communication system for performing network based career management;

FIGS. 3A-3D depict a browser-based career management application accessed through a browser add-on;

FIG. 4 is a flowchart of illustrative steps involved in a career management application;

FIG. 5 is a flowchart of illustrative steps for matching a user profile to opportunities stored in a database; and

FIG. 6 is a flowchart illustrating the steps taken to perform at least one embodiment of a career management plug-in for a web browser.

### DETAILED DESCRIPTION OF THE PREFERRED EMBODIMENT

Employers have been employing others to serve, labor, act, or perform for them, for as long as history has been recorded. Additionally, such employers have been announcing their available positions using various methods, while job-seekers have sought employment in equally diverse ways. For as long as employment has been recorded, employers have sought out persons having desired qualities, skills, traits, attributes, or the like that make them more suitable for the task at hand.

In more modern times, employers have requested potential job candidates to send resume's, details regarding education, job history, publications, and some have requested that essays be written or questionnaire's be filled out. All these things are done in order to help employers determine whether the candidate possesses the traits and skills desired. In yet more modern times, employers have provided websites whereby an applicant can electronically submit essays, answers to questions, in addition to job history, references, and other information. In many cases, employers seek the same or similar information and ask the same or similar questions. Thus job-seekers must take the time to write the same or similar information for each potential employer, which takes a considerable amount of time. Additionally, the job-seeker must then check back with each employer, website, etc. to remained apprised of the status of applications. Finally, due to the proliferation of job sites, job seekers will often see the same job on multiple websites. Repeatedly viewing and reading the same job advertisement is inefficient.

The present application seeks to provide a solution to the aforementioned problems by creating an application, such as a cloud based application accessed with a web browser or a plug-in or browser extension, to aid a job-seeker in tracking, managing, and applying for potential employment positions with one or more potential employers.

For purposes of this application, a web browser may refer to a software application or display produced by steps performed by processing circuitry for retrieving, presenting, interpreting, and traversing information resources provided by a remote server (e.g., on the internet). At the time of this application, web browsers may include Chrome, Firefox, Internet Explorer, Opera, and Safari. In addition, a web application, also referred to as an application or “app” as described herein includes computer software designed to help the user to perform specific tasks on a computer or using a mobile device. The application functions are performed by processing circuitry, such as a computer, mobile device, or server, as further described herein. For purposes of the systems and methods described herein, a plug-in may refer to a set of software components that adds specific abilities to a larger software application, such as a web browser. Plug-ins enable customizing the functionality of an application and may be implemented in any suitable architecture, such as a Flash player, Java applet, HTML5, or any other commonly used platform known in the art. For purposes of method, a plug-in is a general term which could also be synonymously associated with add-ons, snap-ins, and extensions. In certain contexts, the term “application” may also be used to describe a notification and/or response for an employment opportunity.

In one embodiment, when activated, the processing circuitry records any viewed job information (job title, company, location, description, link, application status) in a third party database and displays a search history in a browser panel powered by the plugin. Additionally, job recommendations based on a user's online job search behavior and profile information are displayed by the processing circuitry in a browser overlay pane through the plugin. Finally, the processing circuitry can automatically complete common questions asked on standard job applications and provide updates to users or job seekers on their job application status directly from the employer to which they are applying.

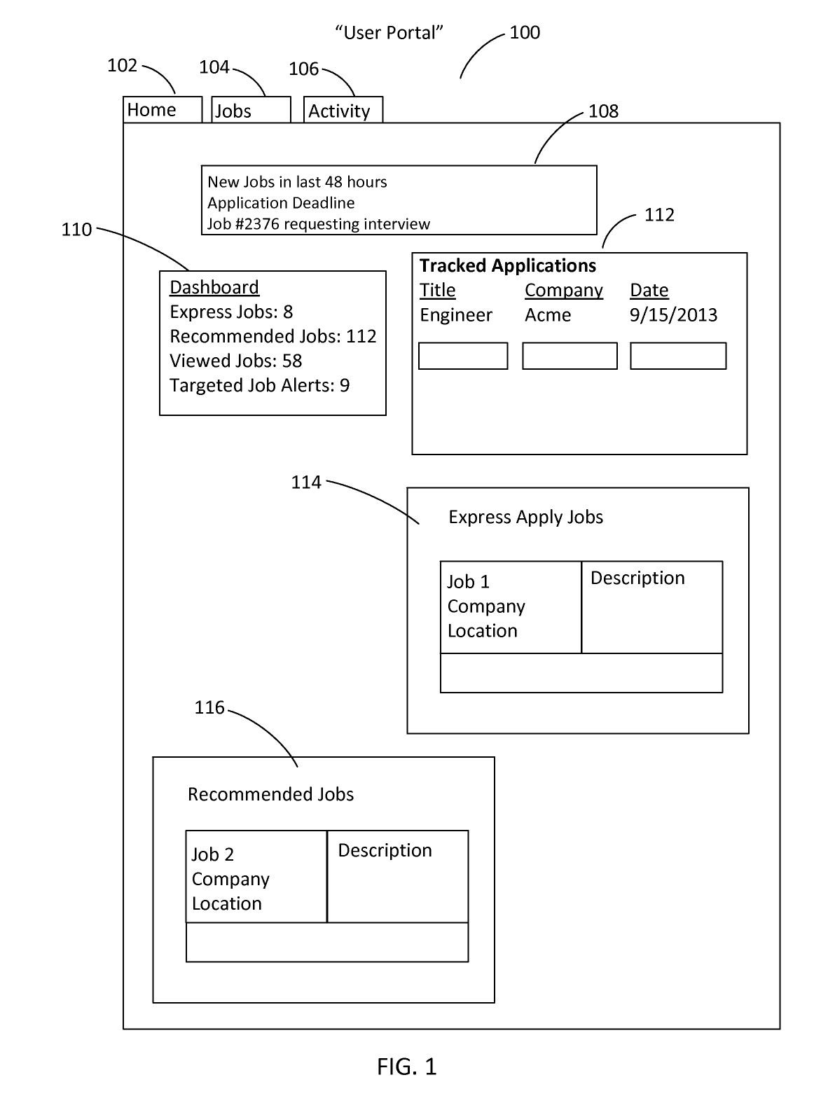

FIG. 1 depicts a user portal for a career management application. User portal 100 is generated by processing circuitry to enable a user to manage the job search process. In certain approaches, portal 100 may be implemented from within a web browser. For example, portal 100 may be generated by processing circuitry upon reading control commands stored at a server, such as those generated by HTML5 or Java computer languages. Portal 100 includes multiple information panes, links, alerts, and other features designed to help a job-seeking user more effectively find potential job opportunities matched to the user's skills, experience, interests, or other characteristics. User portal 100 may be displayed by processing circuitry at a user display, such as a monitor, television, LED display, LCD display, projection, mobile device, or any other suitable display system.

In certain approaches, portal 100 includes one or more tabs, such as home tab 102, jobs tab 104, and activity tab 106. In the depicted example, home tab 102 is shown. When home tab 102 is selected, the processing circuitry may present one or more display panes. For example, alert pane 108 can include high-priority messages or alerts to the user, such as a notification of an interview, upcoming deadline, or potential employment opportunity match identified for a user. Dashboard pane 110 includes summary information regarding the job search process. In certain approaches, dashboard pane 110 includes a summary of one or more of “express apply” jobs, recommended jobs, total jobs viewed by the user, job boards, and targeted job alerts. “Express apply” jobs are job opportunities with applications that can be completed entirely or nearly entirely by the processing circuitry when the user selects them. For these particular job applications, the processing circuitry can access all required application information, such as personal identification data and resume, from memory storage and does not require the user to provide this information, thereby making the process of applying extremely fast for the user. For example, the application information for a user may be stored in a database on a remote server. Additionally or alternatively, the application information for a user may be stored in local memory, such as on a user's computer or mobile device. In certain approaches, these “Express Apply Jobs” are also displayed in “Express Apply Jobs” pane 114. User portal 100 may also include a tracked applications pane 112. Tracked applications pane 112 provides a list of applications which have been previously submitted by the user. For example, it may include a list of the job title, company, and date on which the user applied. Pane 112 may also include user input boxes or buttons to allow the user to input additional job applications, which the user would like the processing circuitry to track. User portal 100 may include a recommended jobs pane 116. These panes may include job opportunities which have been identified by the processing circuitry using an algorithm to match user skills, interests, and experiences, with jobs opportunities stored in a database accessed by the processing circuitry. Pane 116 may include information such as the job title, company, location, and description. In certain approaches, the processing circuitry generates an apply button to allow the user to apply for the job through the user portal 100. In certain approaches, the processing circuitry generates hyperlinks with the messages, notifications, and job listings in some or all of the display panes such that when a user selects the message, text, or image, the processing circuitry presents additional information, a new display, a new pane, or a new page.

Although not depicted, user portal 100 may include additional information accessible through other tabs or links, such as jobs tab 104 and activity tab 106. For example, when jobs tab 104 is selected, the processing circuitry may display a more detailed list of job applications for the user, including, but not limited to, tracked applications, express apply jobs, recommended jobs, and viewed jobs. When activity tab 106 is selected, the processing circuitry may display a more detailed list of user activity, such as recent and upcoming interviews, application activity, updates on applications, and any other relevant information.

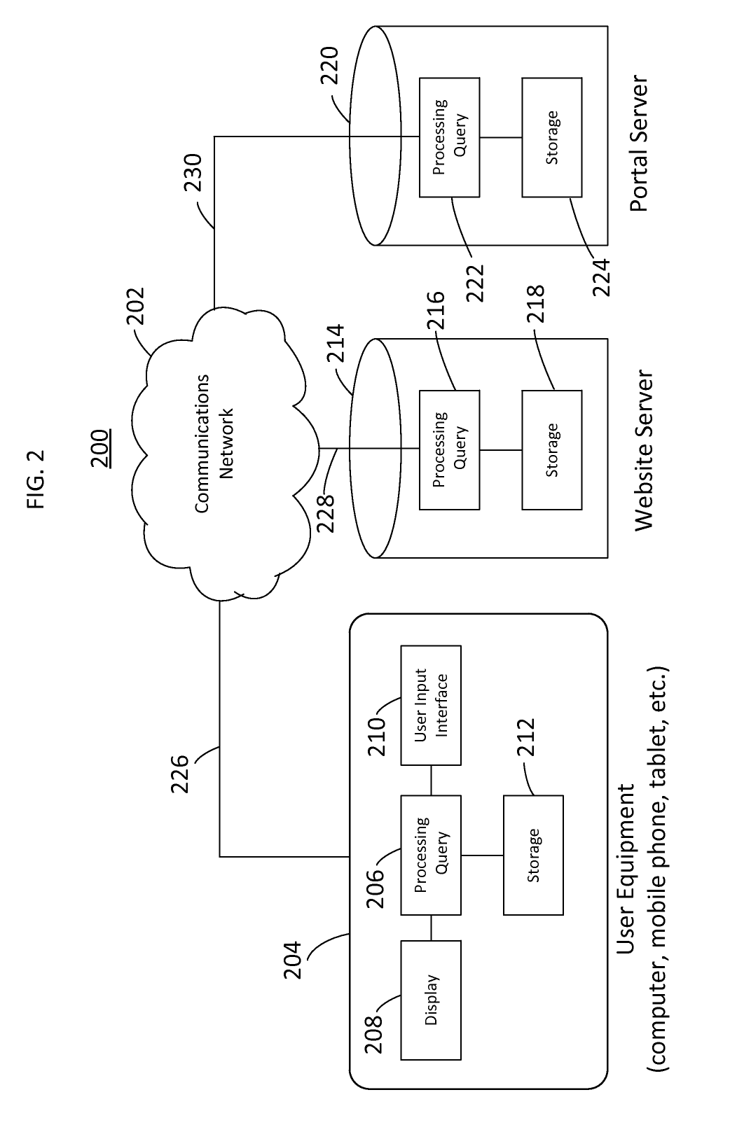

FIG. 2 is a diagram of a communication system for performing network-based career management. System 200 provides communication between multiple information sources, such as local storage, network servers, and application portal servers. In general, this information is shared, communicated, and generated via communications network 202 by one or more processing circuitry components associated with the various information sources. Communications network 202 may be one or more networks, including, but not limited to cable network, local area network (LAN), wireless network, telephone network, cellular network, satellite network, the internet, or any other suitable communication network. Communication paths 226, 228, 230 may accordingly be any appropriate communication path, such as cable lines, fiber optic lines, wireless transmission paths, satellite transmission paths, telephone lines, or any other suitable wired or wireless communication path, or combination thereof.

Users may access the job search management application from one or more of their user equipment devices 204. User equipment may include, but is not limited to, computers, mobile devices, televisions, tablets or any other suitable device. User equipment includes processing circuitry 206 and storage 212. Processing circuitry 206 may be used to send and receive data, commands, user input to or from other network connected systems or devices, such as server processing circuitry 216 of website server 214 and portal processing circuitry 222 of portal server 220. As described herein, processing circuitry, such as processing circuitry 206, 216, and 222, should be understood to mean circuitry, which includes one or more of a microcontroller, integrated circuit, application specific integrated circuit (ASIC), programmable logic device, field programmable gate array (FPGA), digital signal processors, application specific instruction-set processor (ASIP), or any other suitable digital or analog processors.

Processing circuitry may be coupled to electronic storage or memory. For example, processing circuitry 206 is coupled to storage 212, processing circuitry 216 is coupled to storage 218, and portal processing circuitry 222 is coupled to storage 224. Electronic storage, as used herein, may include any appropriate readable memory media, including, but not limited to, RAM, ROM, EPROM, EEPROM, flash memory or other solid state memory technology, CD-ROM, DVD, or other optical storage, magnetic storage devices, or any other physical or material medium for storing desired information, data, instructions, software, firmware, drivers, or code. For example, storage may contain software instructions for controlling the input, output, and other processes of processing circuitry.

In certain approaches, user equipment 204 includes devices for interfacing with a user, such as display 208 and user input interface 210. For example, display 208 may be any suitable display interface, including, but not limited to a monitor, television, LED display, LCD display, projection, mobile device, or any other suitable display system. User input interface 210 may be a keyboard, touchscreen, mouse, microphone, stylus, or any other suitable user input interface. Display 208 and user input 210 allow processing circuitry 206 to provide information to the user and to receive user-generated commands, responses, and data. In certain approaches, processing circuitry 206 stores user-generated information on storage 212, 218, or 224.

System 200 allows for communication between multiple subsystems, such as user equipment 204, website server 214, and portal server 220 for the effective management of the job search process. For example, user processing circuitry 206 may retrieve employment opportunity information (e.g., job application) from website server 214 based on user-specific data stored in storage 224 of portal server 220.

In certain approaches, the job search management software may be implemented from within a browser or browser add-on. For example, a browser may be generated from processing circuitry 206 upon accessing computer processing commands stored on storage 212, which provide input for interpreting data or additional processing information from one or both of website server storage 218 or portal storage 224. Additionally or alternatively, storage 212 may include computer code read by processing circuitry 212 for generating a browser add-on to provide additional functionality through the browser for the user. For example, an add-on may allow fast access to portal 100 or allow automated storing of job search information accessed in the browser.

Portal server 220 stores and processes data related to the user job search. For example, the computer language code for generating user portal 100 may be stored on storage 224 and processed by processing circuitry 222. In certain approaches, storage 224 may store databases related the job search, including, but not limited to, user-specific data, job search history, and job databases. Storing these data in storage 224 is advantageous in that it is readily accessible from virtually anywhere with a communication connection via communications network 202. The processing circuitry, such as processing circuitry 206 and processing circuitry 222 may retrieve stored data to display to the user, such as at display 208, a history of viewed jobs, summary information, and jobs applied the applicant has submitted applications for. For example, the displayed data may include fields including, but not limited to, title, company, data viewed, date applied, and location.

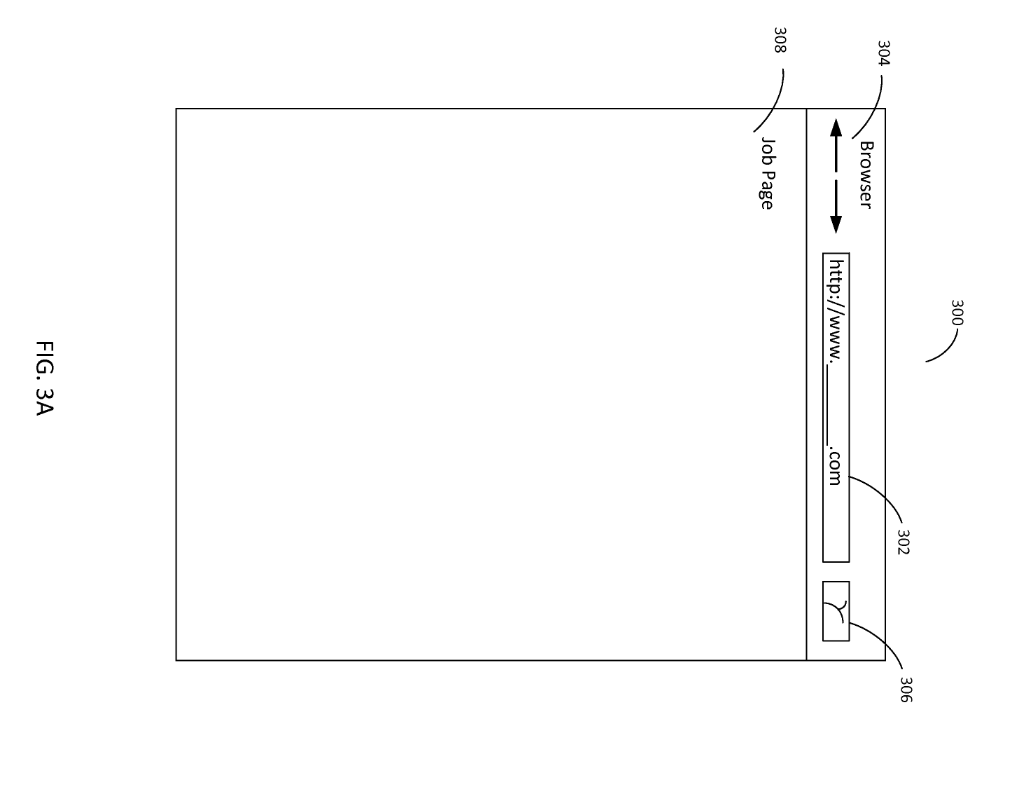

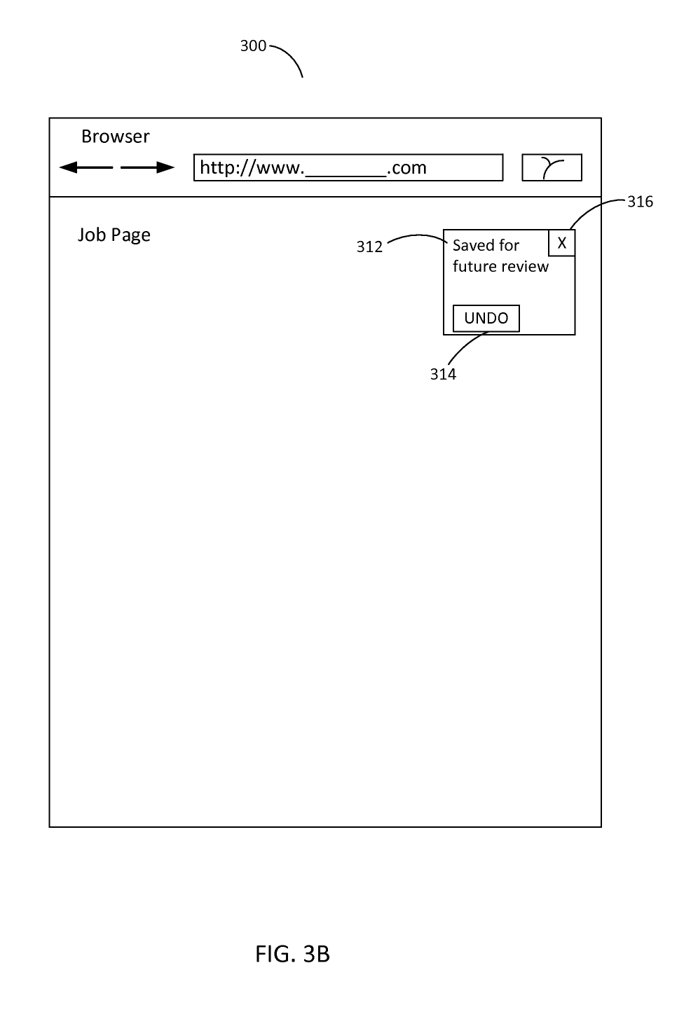

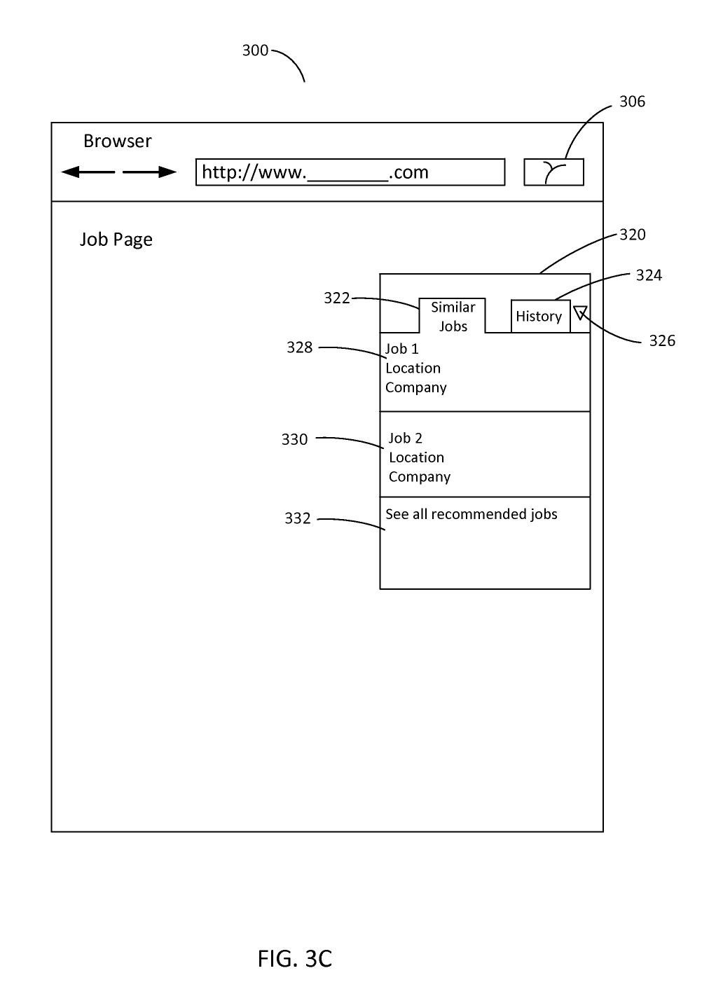

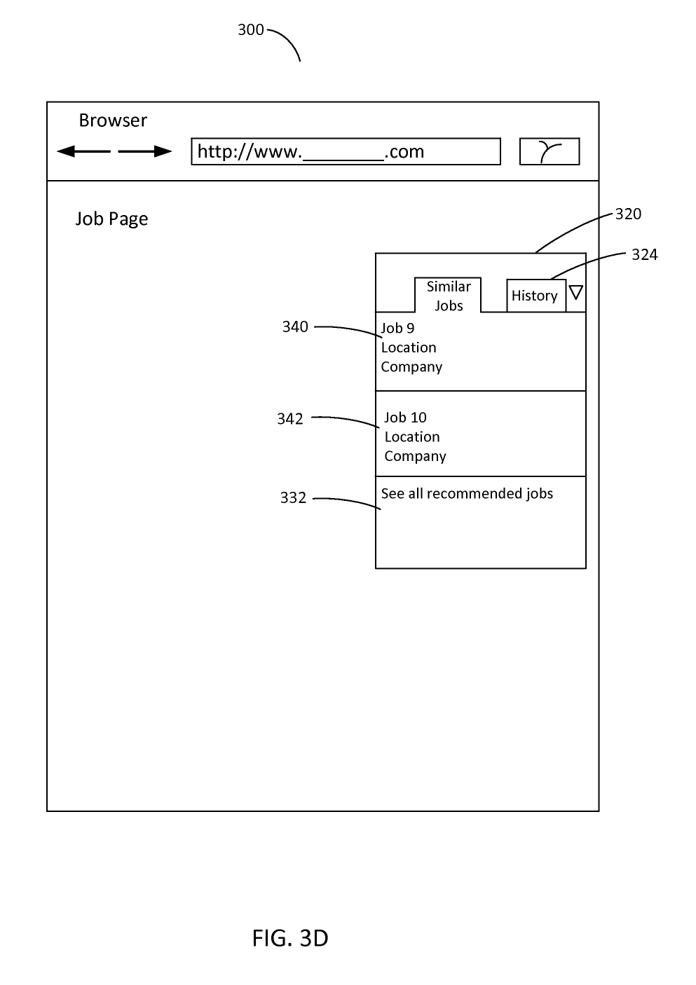

FIGS. 3A-3D depict a browser-based career management application accessed through a browser add-on. Processing circuitry, such as processing circuitry 206, generates a browser display or browser 300 for interpreting, interacting with, and displaying webpage data. As shown in FIG. 3A, in certain approaches, browser 300 includes an address bar 302, for typing in a URL or web address. Browser 300 may also include control buttons 304, which allow quick access to recently visited webpages. Browser 300 also includes a display window 308. In the depicted example, display window 308 depicts a job page or page with a job listing, job application, or other employment information. In certain embodiments, when the add-on is installed (e.g., data and commands recorded in memory 212), icon button 306 is displayed in browser 300. Icon button 306 may be for aesthetic or informational purposes to inform the user that the add-on is properly installed. Additionally or alternatively, icon button 306 may allow the user to turn the add-on capabilities on and off. For example, upon receiving an activation command when the user clicks icon 306, processing circuitry may cycle from an off-state to an on-state, or vice versa.

Upon accessing a webpage with job related information, the processing circuitry may automatically save the job posting in storage. For example, processing circuitry 206 may access a database (e.g., in storage memory 212 or 224) with identifier information for identifying job pages. Identifier information may include, but is not limited to, keywords, companies, and URLs. Processing circuitry 206 may communicate via communications network 202 with portal processing circuitry 222 to store the job posting data in portal storage 224. In certain approaches, the data may be stored locally, such as in storage 212. Job posting data may include, but is not limited to, website URL, job title, company, job description, posting date, application deadline, and contact information. As shown in FIG. 3B, in certain embodiments, the processing circuitry generates a display pane 310 with a message area 312 for notifying the user that the job has been saved for future review within the user's personal profile, such as a profile stored at portal storage 224, which may be accessible through user portal 100. Pane 310 may include user input options, such as an undo button 314 and a close button 316. Upon receiving an undo command from user activation of the undo button 314, the processing circuitry will remove the data from the user's profile data or prevent initial saving of the data. Upon receiving a close command from user activation of the close button 316, the processing circuitry will close pane 310 (i.e., cease displaying pane 310) with the data saved to the user profile.

As shown in FIG. 3C, in certain approaches, the processing circuitry displays pane 320 for identifying similar jobs to that currently displayed in window 308. Pane 320 may include one or more tabs, such as a similar jobs tab 322 and history tab 324. In FIG. 3C, the similar jobs tab 322 has been selected. Processing circuitry may search for jobs saved in the user's profile and/or jobs saved in a general database. For example, portal server 220 may maintain an active list of all open jobs that all users have accessed, and provide automated searching for each user from within that database to find opportunities that an individual user may not have seen yet. Pane 230 may include display areas 328 and 330 for displaying the related jobs identified by the user processing circuitry 206 or the portal processing circuitry 222, or a combination thereof. In certain approaches, the processing circuitry provides access, such as a hyperlink, in display area 332 for viewing all jobs recommended by the processing circuitry, based upon a searching algorithm to find jobs suited for a user. In certain embodiments, pane 320 includes a minimize or close button 326. Upon receiving user input from pressing button 326, the processing circuitry may close or minimize pane 320. In certain approaches, the processing circuitry generates hyperlinks with the messages, notifications, and job listings in some or all of the display areas, such that when a user selects the message, text, or image, the processing circuitry presents additional information, a new display, a new pane, or a new page.

FIG. 3D depicts display pane 320 with the history tab 324 activated. In this embodiment, pane 320 may include display areas 340 and 342 for displaying jobs previously applied to or seen by the user. For example, processing circuitry 206 may provide a command to access stored user data on storage 212 or storage 224, or both. In certain approaches, the processing circuitry generates hyperlinks with the messages, notifications, and job listings in some or all of the display areas, such that when a user selects the message, text, or image, the processing circuitry presents additional information, a new display, a new pane, or a new page.

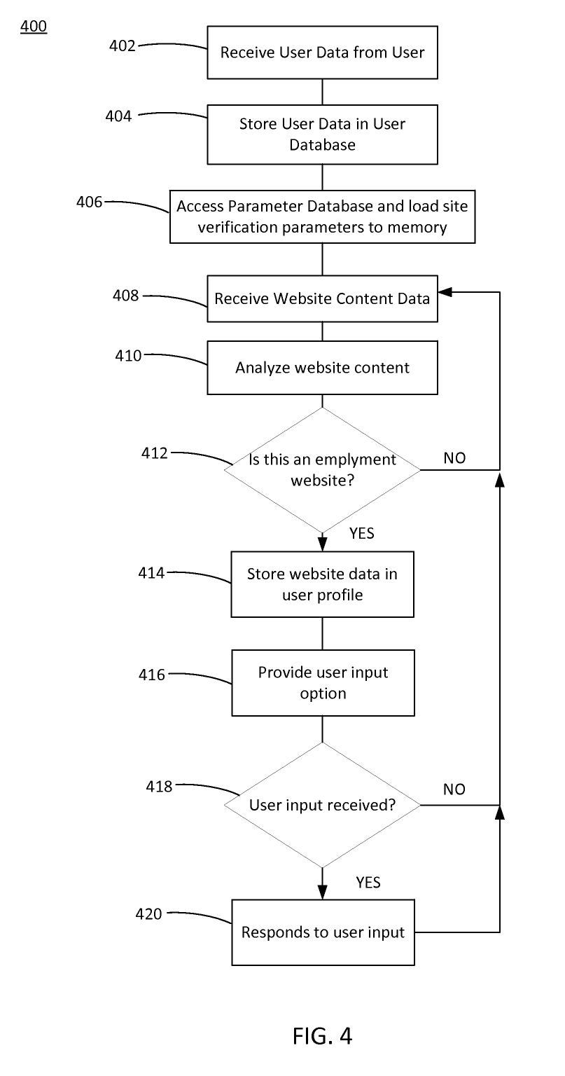

FIG. 4 is a flowchart of illustrative steps involved in a career management application. These steps are performed by processing circuitry, such as user processing circuitry 206, server processing circuitry 216, and portal processing circuitry 222. In process 400, processing circuitry receives user data from a user at step 402. For example, processing circuitry 206 may receive initial user profile data from a user, such as name, address, education, and resume file via user portal 100 or a browser add-on, such as that described in FIGS. 3A-3D. In certain approaches, requesting and receiving this information from a user is done when the user initiates a profile with the service. Additionally or alternatively, the user may update, modify, or change this stored information, for example, through user portal 100. Upon receiving the user data, the processing circuitry proceeds to step 404 and stores the user data in a user database. The user data may be stored locally, such as in storage 212, or remotely, such as in portal storage 224. In certain approaches, processing circuitry 206 stores the user data in the form of a browser cookie. The cookie or user data may include status identifies to enable, disable, or modify process 400. For example, processing circuitry 206 may receive user commands to disable one or more process steps, and processing circuitry 206 may store these data locally, such as in storage 212, or remotely, such as in portal storage 224.

The user processing circuitry performs step 406 by accessing a parameter database for identifying specific types of websites, such as those with job application information. In certain approaches, the parameter database is stored in portal storage 224, thus user processing circuitry 206 requests these parameter data from portal processing circuitry 222. The processing circuitry 206 then loads the site verification parameters to memory, such as in local storage 212. In step 408, processing circuitry, such as circuitry 206, receives website content data from a website server, such as website server 214 via communications network 202. The processing circuitry then analyzes the website content at step 410 to determine if the present website is an employment or job application process. The processing circuitry utilizes the stored verification parameters to classify the content data. For example, the processing circuitry may compare the URL to a specified list or identify specific keywords, code, or features present in the website content data. In certain approaches, the processing circuitry 206 may receive a user command to cease analyzing website information, i.e., to disable process 400.

If, at step 412, the specified parameters for an employment site are not met, the processing circuitry will proceed back to step 408 and continue receiving and monitoring website content data. If at step 412, the specified parameters are met, the processing circuitry proceeds to step 414 and stores the website data in a user profile. In certain approaches, processing circuitry 206 stores the website data in local storage 212. Additionally or alternatively, processing circuitry communicates with portal server 220 via communication network 202 to store the data remotely at storage 224 such that it is readily accessible from any user equipment connected via communication network 202, whether it is a computer, mobile device, tablet, or other system.

At step 416, the processing circuitry provides a user input option, such as a button, text box, response field, or any other appropriate option. For example, the processing circuitry may provide a request from the user to save the employment opportunity (i.e., job posting). In certain approaches, processing circuitry outputs a request for the user to apply for the currently displayed position. In certain approaches, the processing circuitry may further classify the job listing as a recommended job or “express apply” job and then provide a user input, such as a button, to allow the user to apply. In some embodiments, the processing circuitry may provide a notes field, such as a text box, to allow the user to input notes or comments. If no user input is received at step 418, the processing circuitry proceeds to step 408 and continues to monitor website content data. If user input is received, the processing circuitry responds to user input at step 420. For example, if the user requests that the posting is not saved, the processing circuitry will communicate with the portal server to remove the posting from the job history. If the user accepts an invitation to apply by pressing the apply button to provide user input, the processing circuitry will provide additional input and output to facilitate the application processes. If the user declines an invitation to apply (e.g., provides user input to decline by pressing a decline button or waits a sufficient period of time with no specified reply such that the processing circuitry interprets the lack of response as a declination to apply), but does not want to remove the listing, the processing software will store the listing in the user profile history. If the user has provided notes, the processing software will record the notes in the user profile history related to the specific posting. After completing step 420, the processing software proceeds to step 408 for continued monitoring of website content data.

In certain embodiments, the processing circuitry continues to communicate with a website server after identifying an employment opportunity or submitting an application for an employment opportunity. The processing circuitry may track jobs for which the user has applied or seen, and automatically communicate that information to the user, such as at user portal 100 or a direct message (e.g., email, text message) where the user can see a list comprising each job. In certain approaches, portal processing circuitry 222 or user processing circuitry 206 tracks jobs by sending and/or receiving data to or from a remote server (e.g., website server 214) via communications network 202. The data may include status updates regarding the employment opportunity. Additionally or alternatively, when the status for one job changes, the website server and processing circuitry may communicate and notify the user that the status has changed. For example, the portal processing circuitry 222 or user processing circuitry 206 may notify the user by email, a notification at a user portal (e.g., user portal 100), text message, cellular telephone system, and/or a social media site (Twitter, Facebook, etc.). In additional embodiments, the communication between the processing circuitry related to the plugin and website may provide career-networking capabilities by identifying additional job opportunities, networking events, or skill-building events.

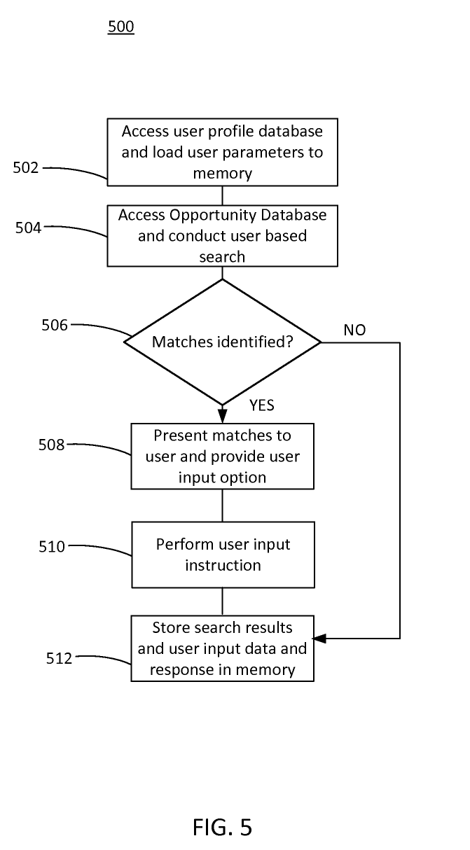

In certain approaches, the job search application as performed by the processing circuitry is configured to match a user's unique profile and characteristics (e.g., education, experience, interests, etc.) with job opportunities to find an improved job fit for the user. FIG. 5 illustrates a process 500 for matching a user profile to opportunities stored in a database.

At step 502, processing circuitry, such as user processing circuitry 206 or portal processing circuitry 222 accesses a user profile database. In certain embodiments, the user profile database is stored in portal storage 224. The profile may contain user characteristics, such as keywords, work experience, skills, education, traits, and interests. The processing circuitry then loads the user characteristics and parameters to accessible local memory (e.g., RAM or other local processing memory) in preparation for conducting a user-based search. At step 504, the processing circuitry accesses an opportunity or job opening and application database. In certain approaches, the opportunity database is stored at portal storage 224. The processing circuitry then searches the database using the user parameters in a specific search algorithm to identify potential matches for the user. The processing circuitry may analyze the employment opportunity content with the user data to determine a user recommendation level for the employment opportunity.

If, at step 506, no matches are identified, the processing circuitry proceeds to step 512 and stores the search results. If at least one match is found, the processing circuitry presents the at least one match to the user at step 508. For example, processing circuitry may display the match in a browser or browser add-on in display 208. In certain approaches, the processing circuitry provides a “matching metric” to the user. For example, the processing circuitry may indicate that this job is a “75% match” or “Great match” or may provide a color indicator of the fit type, such as red (“poor fit”), yellow (“good fit”), or green (“great fit”). At step 508 the processing circuitry also provides a user input option, such as a button, text box, response field, or any other appropriate option. For example, the processing circuitry may provide a request from the user to save the job listing. In certain approaches, processing circuitry outputs a request for the user to apply for the currently displayed position. In certain approaches, the processing circuitry may further classify the job listing as a recommended job or “express apply” job and then provide a user input, such as a button, to allow the user to apply. In some embodiments, the processing circuitry may provide a notes field, such as a text box, to allow the user to input notes or comments.

The processing circuitry then performs any received user input instruction at step 510. For example, if the user requests that the posting is not saved, the processing circuitry will communicate with the portal server to remove the posting from the job history. If the user accepts an invitation to apply, the processing circuitry will provide additional input and output to facilitate the application processes. If the user declines an invitation to apply, but does not want to remove the listing, the processing software will store the listing in the user profile history. If the user has provided notes, the processing software will record the notes in the user profile history related to the specific posting. In certain approaches, no direct user response after a period of time (e.g., 15 seconds) is interpreted by the processing circuitry as a user response to perform a certain task, such as storing the listing in the user profile history. After completing step 510, the processing software proceeds to step 512 to store the search results and any user input. For example, processing circuitry 206 may communicate with portal processing circuitry 222 to store the results in storage 224.

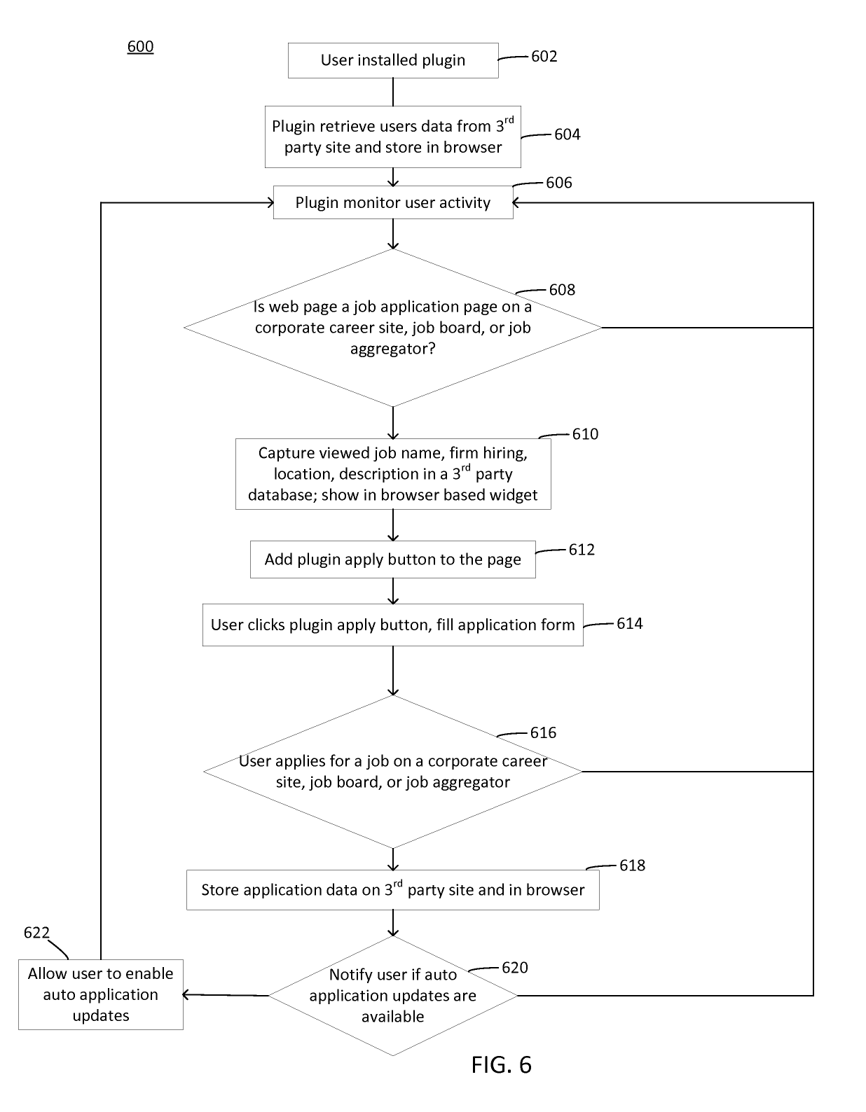

FIG. 6 illustrates at least one embodiment of a method of tracking, managing, and applying for potential employment positions using a browser plugin described in process 600. At step 602, the local processing circuitry receives a user response to install the browser plugin, which is configured to work with all major web browsers. The processing circuitry, such as processing circuitry 206, modifies local storage, such as storage 212, to include the commands and relevant data required to perform the remaining steps of process 600. These commands and data, as performed by the processing circuitry, are considered to be the plugin from the perspective of the user and for the purposes of the systems and methods described herein. In certain approaches, processing circuitry 206 communicates with portal server 220 to retrieve or deliver data associated with a particular user to create or link a user account to the plugin. Step 604 is performed by the processing device as it retrieves a user's data from a third-party site and stores it in a web browser. For example, processing circuitry 206 may retrieve user data from portal server 220 and store the data in storage 212. In certain approaches, processing circuitry 206 stores the user data in the form of a browser cookie. The cookie or user data may include status identifiers to enable, disable, or modify process 600. For example, processing circuitry 206 may receive user commands to disable one or more process steps, and processing circuitry 206 may store these data locally, such as in storage 212, or remotely, such as in portal storage 224.

The processing circuitry monitors the user's web activity at step 606 for operational parameter data that determines if the user is on the job application page of a corporate career site or job board. In step 608, the processing circuitry determines whether the user is currently viewing a job application page of a corporate career site or job board. For example, the processing circuitry may access a parameter database for identifying specific types of websites, such as those with job application information. In certain approaches, the parameter database is stored in portal storage 224, thus user processing circuitry 206 may request these parameter data from portal processing circuitry 222. The processing circuitry 206 may load the site verification parameters to memory, such as in local storage 212. The processing circuitry then analyzes the website content at step 608 to determine if the present website is an employment or job application process. The processing circuitry utilizes the stored verification parameters to classify the content data. For example, the processing circuitry may compare the URL to a specified list or identify specific keywords, code, or features present in the website content data.

If the processing device determines that the web page is not a relevant employment site, the processing step proceeds back to step 606 and continues to monitor the user activity. If the processing device determines that the web page is a relevant employment site, the processing device proceeds to step 610. The processing device captures relevant job information, such as job name, company or firm, and location. The processing circuitry may store the data. For example, the processing circuitry may store the data remotely in storage 224 of portal server 220. In certain approaches, the data is stored locally, such as in storage 212. From the view of the user, the plugin may also be “activated” by the processing circuitry. For example, the processing circuitry may apply an interface button at step 612 to the web page and/or web browser toolbar. In step 614, if the user ‘clicks’ on the interface button generated by the processing circuitry, the processing circuitry receives a user command to fill in the job application form using data that is/has been stored on a third party computer, database, or website. For example, these data may be stored in a database on storage 224 of portal server 220. Additionally or alternatively, if an appropriate answer to a question or input field cannot be pulled from a previously stored data (e.g., on local computer or remote server), the processing circuitry provides an input option for the user to provide new or updated data. This updated user data answer may then be stored by the processing circuitry as part of the user's profile in a user database either locally (e.g., storage 212) or in a networked database (e.g., storage 224). At step 616, the processing circuitry receives a request from the user to submit the application data of the user to a receiving system for receiving the application, i.e., submits the application so that the user has applied for the job.

In certain approaches, the processing circuitry, such as user processing circuitry 206 or portal processing circuitry 222, adjusts user data or user responses to reflect a specific requested response field. For example, an electronic job application may include a question such as, “What is your greatest flaw?” If the user data includes a response to a similar question, such as “What is your biggest weakness?” with text such as, “My biggest weakness is . . . ,” the processing circuitry may adjust the user response to “My greatest flaw is . . . ” so that the response is more appropriate for the specific question. The processing circuitry may use algorithms, look-up databases, or artificial intelligence methods to adjust or improve a user response. In certain approaches, the processing circuitry analyze the job listing for specific keywords or buzzwords used, and adjusts the user response to include these keywords or related words to more directly address the specific job listing. In certain approaches, the processing circuitry analyzes the user responses to improve the flow, language, or grammar of the response. For example, if a user response uses the same word multiple times, the processing circuitry may suggest an alternative word or words, or directly replace the word or words with alternative language. The processing circuitry may also apply spell checking and grammar analysis processes to the user responses and automated responses.

At step 618, the processing circuitry submits the application data of the user to a receiving system for receiving the application, i.e., submits the application so that the user has applied for the job. For example, local processing circuitry 206 may communicate with processing circuitry 216 of server 214 to send the user application data to server 214, where the data can be fully processed and the user may be considered for the job. In certain approaches, processing circuitry 206 may receive communication that the job application was successfully received. Additionally or alternatively, the processing circuitry records in storage (e.g., storage 212 and/or storage 224) whether user request to submit a job was received and whether the job was successfully submitted. The processing circuitry directs to the storage all new responses and application details for future use and the tracking of a job search activity. The processing device continues to monitor submitted applications. For example, processing circuitry 206 may request or receive regular updates from website server 214 regarding the job application.

At step 620, the processing circuitry notifies the user if auto-application updates are available and stores this information in the database associated with user's profile locally (e.g., storage 212), or remotely (e.g., storage 224). These automatic updates inform the user of the status of the application, as well as any future actions that may need to be taken by the user. At step 622, the processing circuitry receives a response confirming automatic updates. The processing circuitry can then provide updates to the user when updates are received and proceed to step 606 for continued monitoring of user activity.

In certain embodiments, step 602 may be performed on additional electronic devices. For example, the plug-in described herein may be installed on a handheld device or tablet. In such embodiments, the plug-in may be what is commonly referred to as a software application, or “app.” Additionally or alternatively, process 600 may be performed by a remote server, such as portal server 220, without additional installation on a user device. These applications are commonly called “cloud applications,” and in certain approaches, are appropriate for the systems and methods described herein.

Also contemplated herein are steps taken by the user to update, refine, edit, or change the information stored in each or any response. When the user submits the job application, the plug-in will review each response and will automatically save the edited answer. In other embodiments, the user will be asked whether or not to save the changes, thus enabling the user to modify certain responses to cater to each employer, while also maintaining a more generic answer on the database. In certain configurations, a plurality of previously reeived or submitted answers associated with one or more questions may be available to choose from for providing a reply.

In additional embodiments, the processing circuitry for the plug-in described herein may be capable of storing and tracking data regarding the employment opportunities for which the user has already submitted his/her application. More specifically, the processing circuitry for the plug-in may be connected to a database that tracks information from over 8000 employers. When a user applies for a position within a company on the database, then tracking information regarding interviews, job offers, position status (e.g., whether the position has been filled by a different person), and other parameters may be made available by the processing circuitry by outputting or displaying at the plug-in.

In additional embodiments, the processing circuitry for the plug-in may use the application submission data (i.e., the jobs for which the user has already applied) to project and display employment opportunities that may be similar to the jobs he/she has already applied for. Parameters for determining whether two or more jobs are similar may include, but are not limited to, job title, geographic location, required skills, traits, abilities, and education, and other parameters commonly used in the art. When such positions are determined, the processing circuitry for the plug-in may suggest the similar positions to the user and provide a more direct way to track, manage, and apply for the position.

In yet additional embodiments, the processing circuitry for the plug-in is tied to and communicates with a website, e.g., communicates with website server 214 via communications network 202. The processing circuitry may track jobs for which the user has applied or seen, and automatically communicate that information to the user, such as at user portal 100 or a direct message (e.g., email, text message) where the user can see a list comprising each job. In certain approaches, portal processing circuitry 222 or user processing circuitry 206 tracks jobs by sending and/or receiving data to or from a remote server (e.g., website server 214) via communications network 202. The data may include status updates regarding the employment opportunity. Additionally or alternatively, when the status for one job changes, the website server and processing circuitry may communicate and notify the user that the status has changed. For example, the portal processing circuitry 222 or user processing circuitry 206 may notify the user by email, a notification at a user portal (e.g., user portal 100), text message, cellular telephone system, and/or a social media site (Twitter, Facebook, etc.). In additional embodiments, the communication between the processing circuitry related to the plugin and website may provide career-networking capabilities by identifying additional job opportunities, networking events, or skill-building events.

It should be understood that the above steps of the flow diagrams of FIGS. 4, 5, and 6 may be executed or performed in any order or sequence not limited to the order and sequence shown and described in the figure. In certain approaches, steps may be excluded. In certain approaches, steps may be added or combined. For example, the steps of process 400 may be combined with the steps of process 500 to provide combined functionality, such as providing a matching metric for a job which the user is currently viewing. Additionally or alternatively, some of the above steps of the flow diagram of FIGS. 4, 5, and 6 may be executed or performed substantially simultaneously where appropriate or in parallel to reduce latency and processing times.

While several embodiments have been described that are exemplary of the present system and methods, one skilled in the art will recognize additional embodiments within the spirit and scope of the systems and methods described herein. Modification and variation can be made to the disclosed embodiments without departing from the scope of the disclosure. Those skilled in the art will appreciate that the applications of the embodiments disclosed herein are varied. Accordingly, additions and modifications can be made without departing from the principles of the disclosure. In this regard, it is intended that such changes would still fall within the scope of the disclosure. Therefore, this disclosure is not limited to particular embodiments, but is intended to cover modifications within the spirit and scope of the disclosure.

What is claimed is:

1. A monitoring system for a web server, comprising:
storage memory; and
processing circuitry configured to:
retrieve user input data from the storage memory;
receive employment opportunity content from a remote server;
analyze the employment opportunity content with the user input data to determine a user recommendation level for the employment opportunity, wherein the employment opportunity content includes employment opportunity information fields;
populate employment opportunity information fields based on user input data;
send populated employment opportunity information fields to a receiving server;
communicate with the receiving server to obtain employment opportunity updates related to the received employment opportunity content; and
send employment opportunity updates to a user notification system.

2. The system of claim 1, wherein the processing circuitry is configured to:
receive website content from the remote server;
access a parameter database having data for classifying employment opportunity content; and
analyze the website content with the data for classifying employment opportunity content to determine whether the website content comprises employment opportunity content.

3. The system of claim 1, wherein the retrieved user input data includes at least one of user resume data, keyword, user response to a question, previously submitted employment application, and previously identified employment opportunity.

4. The system of claim 1, wherein the remote server is the receiving server.

5. The system of claim 1, wherein the storage memory is remote from the processing circuitry.

6. The system of claim 1, wherein the processing circuitry is configured to provide user adjusted responses for employment opportunity information fields based on the analysis of the employment opportunity content.

7. The system of claim 1, wherein the user notification system includes at least one of email, user portal, text message, cellular telephone system, and social media site.

8. The system of claim 1, wherein the processing circuitry is configured to display previously received employment opportunity content.

9. The system of claim 8, wherein the previously received employment opportunity content includes at least one of title, company, location, date of receiving the content, and date of application.

10. The system of claim 1, wherein the processing circuitry is configured to request a user response and receive a user response.

11. The system of claim 10, wherein the processing circuitry saves the user response with user input data at the storage memory.

12. A monitoring system for a web server, comprising:
storage memory; and
processing circuitry configured to:
retrieve user input data from the storage memory;
receive employment opportunity content from a remote server, wherein the employment opportunity content includes user information fields;
analyze the employment opportunity content with the user input data to determine a user recommendation level for the employment opportunity;
send populated user information fields to a receiving server;
communicate with the receiving server to obtain employment opportunity updates related to the received employment opportunity content; and
send employment opportunity updates to user notification system.

13. A monitoring system for a web server, comprising:
storage memory; and
processing circuitry configured to:
receive website content from a remote server;
access a parameter database having data for classifying an employment website;
analyze the website content with the data for classifying an employment site to determine whether the website content is an employment website;
in response to determining that the website content is an employment website, access a portal server to store application data from the employment website in a user database;
receive user input data; and
in response to the user input data, store user input data in user database.

14. The monitoring system of claim 11, wherein the parameter database comprises a list of at least one of websites, keywords, companies, and URLs.

15. The monitoring system of claim 11, wherein the processing circuitry is further configured to automatically populate information for given application data based on stored user input data.

16. The monitoring system of claim 13, wherein the processing circuitry is configured to send populated information for application data to an application receiving server.

17. The monitoring system of claim 11, wherein the processing circuitry is configured to
communicate with the receiving server to obtain employment opportunity updates; and
send employment opportunity updates to a user notification system.

18. The system of claim 11, wherein the processing circuitry is configured to provide user adjusted responses for employment opportunity information fields based on the analysis of the employment opportunity content.

19. The system of claim 11, wherein the processing circuitry is configured to display previously received employment opportunity content.

20. The system of claim 17, wherein the previously received employment opportunity content includes at least one of title, company, location, date of receiving the content, and date of application.

21. A method for monitoring a web server, comprising:
retrieving, with processing circuitry, user data from a storage memory;
receiving, at the processing circuitry, employment opportunity content from a remote server;
analyzing, with the processing circuitry, the employment opportunity content with the user data to determine a user recommendation level for the employment opportunity;
populating, with the processing circuitry, employment opportunity information fields based on stored user input data;
sending, with the processing circuitry, populated employment opportunity information fields to a receiving server;
communicating, with the processing circuitry, with the receiving server to obtain employment opportunity updates; and
sending, with the processing circuitry, employment opportunity updates to a user notification system.

22. The method of claim 21, further comprising:
receiving, with the processing circuitry, website content from the remote server;
accessing, with the processing circuitry, a parameter database having data for classifying employment opportunity content; and
analyzing, with the processing circuitry, the website content with the data for classifying employment opportunity content to determine whether the website content comprises employment opportunity content.

23. The method of claim 21, wherein the retrieved user input data includes at least one of user resume data, keyword, user response to a question, previously submitted employment application, and previously identified employment opportunity.

24. The method of claim 21, wherein the remote server is the receiving server.

25. The method of claim 21, wherein the storage memory is remote from the processing circuitry.

26. The method of claim 21, further comprising providing, with the processing circuitry, user adjusted responses for employment opportunity information fields based on the analysis of the employment opportunity content.

27. The method of claim 21, wherein the user notification system includes at least one of email, user portal, text message, cellular telephone system, and social media site.

28. The method of claim 21, further comprising displaying, with the processing circuitry, previously received employment opportunity content.

29. The method of claim 28, wherein the previously received employment opportunity content includes at least one of title, company, location, date of receiving the content, and date of application.

30. The method of claim 21, further comprising requesting, with the processing circuitry, a user response, and receiving, with the processing circuitry, a user response.

31. The method of claim 30, further comprising saving, with the processing circuitry, the user response with user input data at the storage memory.

32. A method for monitoring a web server, comprising:
receiving, with processing circuitry, website content from a remote server;
accessing, with the processing circuitry, a parameter database having data for classifying an employment website;
analyzing, with the processing circuitry, the website content with the data for classifying an employment site to determine whether the website content is an employment website;
in response to determining that the website content is an employment website, accessing, with the processing circuitry, a portal server to store application data from the employment website in a user database;
receiving, with the processing circuitry, user input data; and
in response to the user input data, storing, with the processing circuitry, user input data in user database.

33. The method of claim 32, wherein the parameter database comprises a list of at least one of websites, keywords, companies, and URLs.

34. The method of claim 32, further comprising automatically populating information for given application data based on stored user input data with the processing circuitry.

35. The method claim 34, further comprising sending populated information for application data to an application receiving server with the processing circuitry.

36. The method system of claim 32, further comprising
communicating, with the processing circuitry, with the receiving server to obtain employment opportunity updates; and
sending, with the processing circuitry, employment opportunity updates to a user notification system.

37. The method of claim 32, further comprising providing, with the processing circuitry, user adjusted responses for employment opportunity information fields based on the analysis of the employment opportunity content.

38. The method of claim 32, further comprising displaying, with the processing circuitry, previously received employment opportunity content.

39. The method of claim 38, wherein the previously received employment opportunity content includes at least one of title, company, location, date of receiving the content, and date of application.
